(19) United States
(12) Patent Application Publication
(10) Pub. No.: US 2025/0053333 A1
(43) Pub. Date: Feb. 13, 2025

(54) CONTROLLER AND STORAGE DEVICE

(71) Applicant: SK hynix Inc., Gyeonggi-do (KR)

(72) Inventors: Chi Ho KIM, Gyeonggi-do (KR); Do Hyung KIM, Gyeonggi-do (KR); Jea Young ZHANG, Gyeonggi-do (KR); Hoe Seung JUNG, Gyeonggi-do (KR)

(21) Appl. No.: 18/392,917

(22) Filed: Dec. 21, 2023

(30) Foreign Application Priority Data
Aug. 9, 2023 (KR) 10-2023-0103873

(51) Int. Cl. G06F 3/06

(52) U.S. Cl. CPC G06F 3/0656; G06F 3/0604; G06F 3/0679

(57) ABSTRACT

In an embodiment of the disclosed technology, a storage device starts in advance loading map data before outputting a signal corresponding to a read buffer command of a host device, encodes map data using a plurality of map load areas and a plurality of encoding areas, and provides encoded map data to the host device.

### CROSS-REFERENCE TO RELATED APPLICATION

The present application claims priority under 35 U.S.C. § 119 (a) to Korean Patent Application No. 10-2023-0103873 filed on Aug. 9, 2023, which is incorporated herein by reference in its entirety.

### BACKGROUND

### 1. Technical Field

Various embodiments of the disclosed technology generally relate to a controller and a storage device.

### 2. Related Art

A storage device may include a memory which includes a plurality of memory cells and stores data. The storage device may include a controller which controls the operation of the memory.

For example, the controller may control an operation of writing data to the memory according to a command inputted from a host device located at the outside the storage device. The controller may control an operation of reading or erasing data written to the memory according to a command inputted from the host device.

A certain amount of time may be required for the operation of the storage device according to a command of the host device. Therefore. measures capable of reducing the amount of time are sought after to improve the performance of the storage device.

### SUMMARY

Various embodiments of the disclosed technology are directed to providing measures capable of reducing a time needed for the operation of a storage device according to a command of a host device and improving data processing speed when viewed from the side of the host device.

In an embodiment of the disclosed technology, a storage device may include: a memory including a plurality of storage areas; and a controller configured to transmit, to a host device, a read buffer recommend signal on the basis of a read count for data stored in each of the plurality of storage areas, and start a load operation of storing in a buffer memory, map data associated with the read buffer recommend signal before receiving, from the host device, a read buffer command corresponding to the read buffer recommend signal.

In an embodiment of the disclosed technology, a controller may include: a buffer memory; a first processor configured to output a read buffer hint signal when a read count is greater than or equal to a preset value, the read count for data stored in each of a plurality of storage areas included in an external memory, and start a load operation of storing map data associated with the read buffer hint signal in the buffer memory; and a second processor configured to transmit, to a host device, a read buffer recommend signal in response to the read buffer hint signal, the read buffer recommend signal being transmitted after the load operation is started.

In an embodiment of the disclosed technology, a controller may include: a buffer memory; a first processor configured to output a read buffer hint signal when a read count is greater than or equal to a preset value, the read count for data stored in each of a plurality of storage areas included in an external memory, and store, in a map data area of the buffer memory, map data associated with the read buffer hint signal; and a second processor configured to transmit, to a host device, a read buffer recommend signal in response to the read buffer hint signal, wherein the second processor transmits, to the host device, a first read buffer recommend signal and a second read buffer recommend signal, encodes first map data stored in a first map load area of the buffer memory and stores the encoded first map data in a first encoding area of the buffer memory in response to a first read buffer command corresponding to the first read buffer recommend signal, and encodes second map data stored in a second map load area of the buffer memory and stores the encoded second map data in a second encoding area of the buffer memory in response to a second read buffer command corresponding to the second read buffer recommend signal.

According to the embodiments of the disclosed technology, it is possible to reduce a time required for the operation a storage device according to a command of a host device, thereby improving the performance of the storage device and data processing speed by the host device.

### BRIEF DESCRIPTION OF THE DRAWINGS

FIG. 1 is a diagram illustrating an example of the schematic configuration of a storage device based on an embodiment of the disclosed technology.

FIG. 2 is a diagram illustrating an example of a method in which the storage device provides map data to a host device based on an embodiment of the disclosed technology.

FIGS. 3 and 4 are diagrams illustrating examples of processes in which the storage device loads map data to provide map data to the host device based on an embodiment of the disclosed technology.

FIGS. 5 to 9 are diagrams illustrating examples of methods in which the storage device to provide a plurality of map data elements (or chunks or items) to the host device based on an embodiment of the disclosed technology.

FIG. 10 is a diagram illustrating an example of a method in which the storage device loads and encodes map data. based on an embodiment of the disclosed technology

### DETAILED DESCRIPTION

In the following description of examples or embodiments of the disclosed technology, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosed technology, detailed descriptions of well-known functions and components incorporated herein will be omitted when it is determined that the description may make the subject matter in some embodiments of the disclosed technology rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosed technology. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the disclosed technology will be described in detail with reference to accompanying drawings.

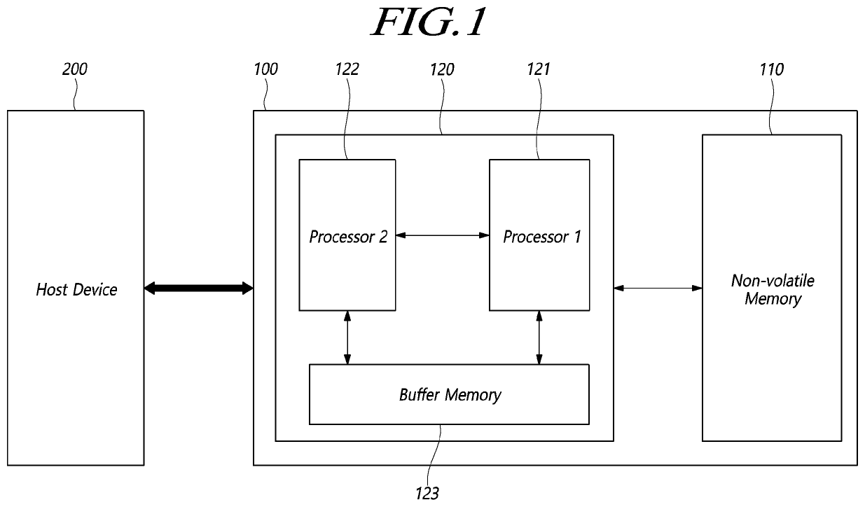

FIG. 1 is a diagram illustrating an example of the schematic configuration of a storage device 100 based on an embodiment of the disclosed technology.

Referring to FIG. 1, the storage device 100 based on the embodiment of the disclosed technology may include a memory 110, and a controller 120 which controls the operation of the memory 110.

For example, the memory 110 may be implemented into various types of non-volatile memories such as a NAND flash memory, a 3D NAND flash memory, a NOR flash memory, a resistive random access memory (RRAM), a phase-change random access memory (PCRAM), a magnetoresistive random access memory (MRAM), a ferroelectric random access memory (FeRAM) and a spin transfer torque random access memory (STT-RAM). The memory 110 may be implemented into a three-dimensional array structure. The embodiment of the disclosed technology may be applied to not only a flash memory in which a charge storage layer is configured by a floating gate but also a charge trap flash in which a charge storage layer is configured by an insulating film.

The memory 110 may include a plurality of memory blocks. The memory blocks may also be referred to as storage blocks. The memory 110 may include a memory cell array including a plurality of memory cells which store data, and the memory cell array may exist in a memory block.

The memory 110 may operate in response to control of the controller 120. Operations of the memory 110 may include, for example, a program operation (also referred to as a “write operation”), an erase operation and a read operation.

The controller 120 may control program, erase, read and background operations on the memory 110. The background operation may include, for example, at least one of garbage collection, wear leveling, read reclaim and bad block management.

The controller 120 may control the operation of the memory 110 according to a request of a host device located outside the storage device 100. Alternatively, the controller 120 may control the operation of the memory 110 regardless of a request from the host device.

In the illustrated example, the controller 120 may control the operation of the memory 110 according to a request of a host device 200. The storage device 100 and the host device 200 may be collectively referred to as a computing system.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of be driven under human control or autonomous driving, etc. Alternatively, the host device 200 may be a virtual/augmented reality (VR/AR) device which provides a 2D or 3D virtual reality image or augmented reality image. Besides, the host device 200 may be any of various electronic devices which require the storage device 100 capable of storing data.

The host device 200 may include at least one operating system. The operating system may manage and control overall functions and operations of the host device 200, and may control interoperations between the host device 200 and the storage device 100. The operating system may be classified into a general operating system and a mobile operating system depending on the mobility of the host device 200.

The controller 120 and the host device 200 may be devices which are separated from each other. In one embodiment, the controller 120 and the host device 200 may be implemented by being incorporated into one device. Hereunder, it will be described as an example that the controller 120 and the host device 200 are devices which are separated from each other.

The controller 120 may include a host interface which provides an interface for communication with the host device 200. The controller 120 may include a memory interface which provides an interface for communication with the memory 110.

The controller 120 may include a control circuit which controls overall operations of the controller 120. The control circuit may include, for example, at least one of a processor, a working memory and so on, and may optionally include an error detection and correction circuit.

The control circuit may communicate with the host device 200 through the host interface, and may communicate with the memory 110 through the memory interface.

The control circuit may perform a function of interpreting a command inputted from the host device 200 and transferring the command to the memory 110. This function may be performed by the processor included in the control circuit.

In the illustrated example of FIG. 1, the control circuit may include a first processor 121 and a second processor 122.

The first processor 121 and the second processor 122 may be physically distinguished circuits, or may be configurations which are functionally distinguished in a single circuit. For example, the first processor 121 and the second processor 122 may be implemented in the form of separate chips, or may be implemented in the form of a single chip.

The first processor 121 may correspond to, for example, a flash translation layer (FTL). The first processor 121 may translate a logical block address provided by the host device 200 into a physical block address. The first processor 121 may receive a logical block address and translate the logical block address into a physical block address using a mapping table.

The second processor 122 may correspond to, for example, a host interface layer (HIL). The second processor 122 may interpret a command inputted to the storage device 100 from the host device 200, and may transfer the command to the first processor 121.

Furthermore, the control circuit may include a flash interface layer (FIL) which transfers a command instructed by the first processor 121 to the memory 110.

The control circuit may execute, for example, firmware to control the operation of the controller 120. The control circuit may execute (drive), upon booting, firmware included in the working memory. An operation of the storage device 100 described in an embodiment of the disclosed technology may be implemented in such a way that the control circuit executes firmware in which the corresponding operation is defined.

Firmware, is a program to be executed in the storage device 100 to drive the storage device 100, and may include various functional layers corresponding to the processor described above. For example, the firmware may include binary data in which codes for executing the respective functional layers are defined.

For example, the firmware may be loaded into the working memory from the memory 110 or a separate nonvolatile memory (e.g., a ROM or a NOR Flash) located outside the memory 110. The control circuit may first load the entirety or a part of the firmware into the working memory when executing a booting operation after power-on.

The control circuit may perform a logical operation which is defined in the firmware loaded into the working memory, to control the overall operations of the controller 120. The control circuit may control the controller 120 to generate a command or a signal, according to a result of performing the logical operation defined in the firmware. When a portion of the firmware in which a logical operation to be performed is defined is not loaded into the working memory, the control circuit may generate an event (e.g., an interrupt) for loading the corresponding portion of the firmware into the working memory.

The working memory may store firmware necessary to drive the controller 120, program codes, commands or data.

The working memory may be located inside or outside the controller 120. In one embodiment, working memories may be located inside and outside the controller 120.

In the illustrated example of FIG. 1, the working memory may be a buffer memory 123. Alternatively, the buffer memory 123 may be disposed separately from the working memory. The buffer memory 123 may be located inside or outside the controller 120.

The working memory or the buffer memory 123, for example, may include at least one among volatile memories such as a static RAM (SRAM), a dynamic RAM (DRAM) and a synchronous DRAM (SDRAM).

In the process of controlling the operation of the memory 110 according to a command of the host device 200, the controller 120 may perform control for improving the operational performance of the storage device 100 according to a type of the command of the host device 200 or an operating state of the memory 110.

For example, the storage device 100 may control an operation of providing, to the host device 200, map data associated with data whose read count by the host device 200 is great. Map data may be, for example, data indicating the mapping relationship between a logical block address transmitted from the host device 200 and a physical block address of the memory 110. By providing map data to the host device 200, the performance of a read operation by the host device 200 may be improved. If the map data is not provided to the host device 200, it is necessary for the controller 120 to read the map data stored in the memory 110 for processing read command of the host device 200. But if the map data is provided to the host device 200, the controller 120 can provide user data according to the read command without reading the map data from the memory 110.

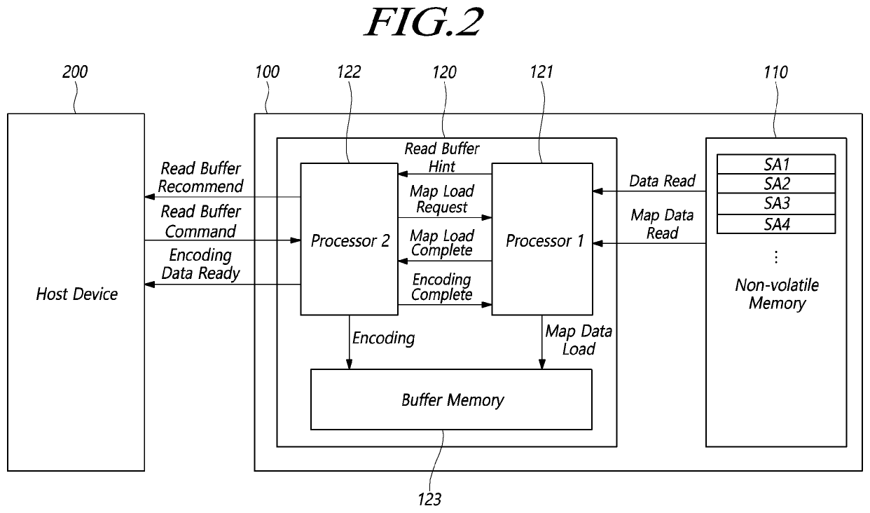

FIG. 2 is a diagram illustrating an example of a method in which the storage device 100 provides map data to the host device 200 based on an embodiment of the disclosed technology.

Referring to FIG. 2, the controller 120 of the storage device 100 may control an operation of reading data stored in the memory 110, according to a command received from the host device 200. The controller 120 may read data stored in the memory 110 and transmit the data to the host device 200.

The memory 110 may include a plurality of storage areas SA, for example, SA1-SA4, and the plurality of storage areas SA may correspond to at least one memory block.

The controller 120 may control a read operation according to a command of the host device 200, and may count read counts for the storage areas SA included in the memory 110. When a read count for a storage area SA is greater than or equal to a preset value, the controller 120 may control an operation for providing, to the host device 200, map data associated with the corresponding storage area SA.

For example, the first processor 121 of the controller 120 may count a read count according to a read operation, and, when the read count is greater than or equal to the preset value, may output a read buffer hint signal for providing map data for a corresponding storage area SA. The first processor 121 may transmit the read buffer hint signal to the second processor 122.

In response to the read buffer hint signal, the second processor 122 may transmit a read buffer recommend signal to the host device 200.

In response to the read buffer recommend signal, the host device 200 may transmit, to the controller 120, a read buffer command corresponding to the read buffer recommend signal. The read buffer command may be a command which requests providing the map data for the storage area SA according to the read buffer recommend signal.

In response to the read buffer command, the second processor 122 of the controller 120 may transmit, to the first processor 121, a map load request signal which requests loading the corresponding map data.

The first processor 121 may perform an operation of loading the map data stored in the memory 110 according to the map load request signal. The first processor 121 may read the map data stored in the memory 110 and store the map data in the buffer memory 123.

When loading the map data into the buffer memory 123 is completed, the first processor 121 may transmit a map load complete signal to the second processor 122.

In response to the map load complete signal, the second processor 122 may perform an operation of encoding the map data loaded into the buffer memory 123. The second processor 122 may store encoded map data in an area different from an area in which the map data is stored in the buffer memory 123. In the present specification, encoded map data may be referred to as encoded data.

When encoding the map data is completed, the second processor 122 may transmit an encoding data ready signal to the host device 200. Further, the second processor 122 may transmit an encoding complete signal to the first processor 121.

In response to the encoding data ready signal, the host device 200 may perform an operation of bringing the encoded data stored in the buffer memory 123 to a host memory included in the host device 200. The host device 200 may transmit, to the storage device 100, a read command based on the map data stored in the host memory, thereby reducing a time required for a read operation and improving the performance of the read operation.

To improve the performance of a control operation of providing map data to the host device 200, the controller 120 may variously control a time point of loading the map data into the buffer memory 123.

For example, the first processor 121 of the controller 120 may start a load operation of storing, in the buffer memory 123, map data stored in the memory 110 before transmitting the read buffer hint signal to the second processor 122. Alternatively, the first processor 121 may start a load operation at a time point of transmitting the read buffer hint signal or before receiving the map load request signal after transmitting the read buffer hint signal.

Since the first processor 121 starts the load operation of the map data before the read buffer command corresponding to the read buffer hint signal is received in the second processor 122 or before the map load request signal according to the read buffer command is received in the first processor 121, it is possible to prevent or reduce a time delay according to the load operation of the map data.

A time point at which map data is loaded into the buffer memory 123 by the first processor 121 may be advanced, and a time point at which map data may be provided to the host device 200 may be advanced. Since the delay of a time point at which map data for a storage area SA whose read count is large is provided to the host device 200 is prevented or reduced, it is possible to improve the performance of a read operation.

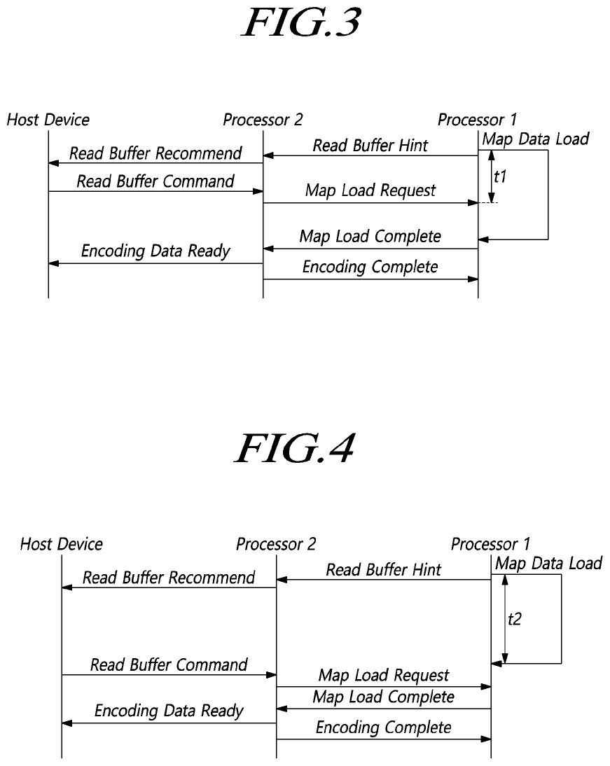

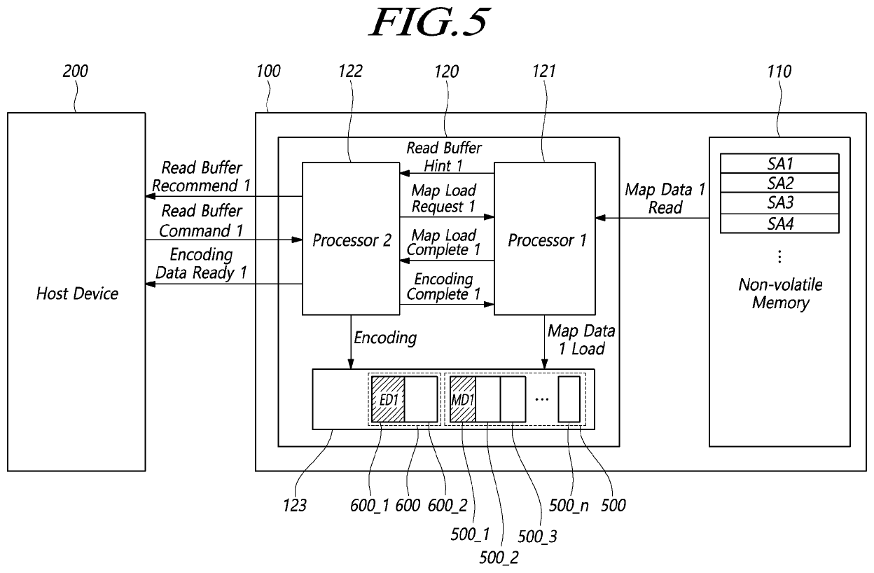

FIGS. 3 and 4 are diagrams illustrating examples of processes in which the storage device 100 loads map data to provide map data to the host device 200 based on an embodiment of the disclosed technology.

Referring to FIG. 3, when it is determined that a storage area SA whose read count is greater than or equal to a preset value, the first processor 121 may output the read buffer hint signal to the second processor 122. When it is determined to output the read buffer hint signal, the first processor 121 may start a load operation of storing, in the buffer memory 123, map data for the corresponding storage area SA, before outputting the read buffer hint signal. Alternatively, the first processor 121 may start a load operation after outputting the read buffer hint signal.

The second processor 122 may transmit, to the host device 200, the read buffer recommend signal in response to the read buffer hint signal. The second processor 122 may receive the read buffer command corresponding to the read buffer recommend signal from the host device 200.

In response to the read buffer command, the second processor 122 may transmit the map load request signal to the first processor 121.

The example shown in FIG. 3 represents a case where map loading is being performed at a time point at which the first processor 121 receives the map load request signal.

When loading the map data is completed after receiving the map load request signal, the first processor 121 may transmit the map load complete signal to the second processor 122. In response to the map load complete signal, the second processor 122 may encode the map data stored in the buffer memory 123. When encoding is completed, the second processor 122 may transmit the encoding data ready signal to the host device 200 and transmit the encoding complete signal to the first processor 121.

As shown as a time t1 in FIG. 3, the first processor 121 starts the load operation of the map data before outputting the read buffer hint signal. Thus, in comparison to a case where a load operation of map data is started after receiving the map load request signal, a load operation of map data is started earlier as time t1. Accordingly, a timing that the map data load is completed may be advanced.

A time to be reduced may increase according to a time point at which the read buffer command is transmitted from the host device 200 to the controller 120.

In the example as shown in FIG. 4, the read buffer hint signal may be outputted and a load operation of map data may be started, by the first processor 121.

A time point at which the host device 200 having received the read buffer recommend signal from the second processor 122 transmits the read buffer command may vary according to the operation of the host device 200. For example, a time point at which the read buffer command is transmitted by the host device 200 may be a time point at which the load operation of the map data by the first processor 121 is completed.

In this case, a time point at which the map load request signal corresponding to the read buffer command is received in the first processor 121 may correspond to a state in which the load operation of the map data completed. The first processor 121 may transmit, to the second processor 122, the map load complete signal corresponding to the map load request signal. The process of encoding the map data and the process of providing encoded data to the host device 200 may be performed without delay.

Since the load operation of the map data is completed before the read buffer command or the map load request signal is received, which corresponds to a time t2 shown in FIG. 4, the process of providing the map data to the host device 200 may be reduced.

By reducing a time required for an operation of improving the performance of a read operation by providing map data to the host device 200, the performance of a read operation for data stored in a storage area SA whose read count is large may be improved.

In an embodiment of the disclosed technology, when there are a plurality of storage areas SA whose read counts are greater than or equal to a preset value, a plurality of map data elements (or chunks or items) may be loaded and encoded, and thereby, the performance of an operation of providing map data to the host device 200 may be further improved.

FIGS. 5 to 9 are diagrams illustrating examples of methods in which the storage device 100 loads map data to provide a plurality of map data elements to the host device 200 based on an embodiment of the disclosed technology.

Referring to FIG. 5, the illustration corresponds to a case where a read count for a first storage area SA1 among a plurality of storage areas SA1, SA2, SA3, SA4, . . . included in the memory 110 is greater than or equal to a preset value.

When the read count for the first storage area SA1 is greater than or equal to the preset value, the controller 120 may perform an operation for providing, to the host device 200, map data for the first storage area SA1.

For example, the first processor 121 may transmit a first read buffer hint signal to the second processor 122. Before transmitting the first read buffer hint signal, the first processor 121 may start a load operation for storing first map data MD1 for the first storage area SA1 in the buffer memory 123. In one embodiment, the first processor 121 may start the load operation simultaneously with outputting the first read buffer hint signal or after outputting the first read buffer hint signal.

The buffer memory 123 may include a plurality of map load areas 500. For example, the buffer memory 123 may include n number of map load areas 500_1, 500_2, 500_3, . . . , 500_n, where n is an integer greater than or equal to 2, i.e., n≥2.

The first processor 121 may perform a load operation of storing the first map data MD1 in the first map load area 500_1 of the buffer memory 123.

In response to the first read buffer hint signal, the second processor 122 may transmit a first read buffer recommend signal to the host device 200. The second processor 122 may receive, from the host device 200, a first read buffer command corresponding to the first read buffer recommend signal.

In response to the first read buffer command, the second processor 122 may transmit, to the first processor 121, a first map load request signal corresponding to the first read buffer command.

At a time point at which the first processor 121 receives the first map load request signal, it may be a state in which the load operation of the first map data MD1 is in progress or a state in which the load operation of the first map data MD1 is completed.

When the load operation of the first map data MD1 is completed, the first processor 121 may transmit a first map load complete signal to the second processor 122. As the first processor 121 starts the load operation of the first map data MD1 in advance, a time point of transmitting the first map load complete signal to the second processor 122 may not be delayed.

In response to the first map load complete signal, the second processor 122 may encode the first map data MD1 stored in the first map load area 500_1, and thereby, may store the encoded data in an encoding area 600 of the buffer memory 123.

The buffer memory 123 may include, for example, M number of encoding areas 600, where M is an integer satisfying the relationship n≥M≥2. For example, FIG. 5 illustrates a case where the buffer memory 123 includes two encoding areas 600_1 and 600_2.

The second processor 122 may encode the first map data MD1 and store the encoded data in the first encoding area 600_1.

When first encoded data ED1 obtained by encoding the first map data MD1 is stored in the first encoding area 600_1, the second processor 122 may transmit a first encoding data ready signal to the host device 200.

The second processor 122 may transmit a first encoding complete signal to the first processor 121. In response to the first encoding complete signal, the first processor 121 may recognize the first map load area 500_1 as a usable area.

The host device 200 may take the first encoded data ED1 stored in the first encoding area 600_1 at a necessary time point and use the first encoded data ED1 when transmitting a read command. Therefore, the first encoding area 600_1 may be an unusable area until the host device 200 takes the first encoded data ED1 stored in the first encoding area 600_1.

In an embodiment of the disclosed technology, as the plurality of map load areas 500 and the plurality of encoding areas 600 are provided, delay due to a time of encoding map data in the process of providing the map data to the host device 200 may be reduced.

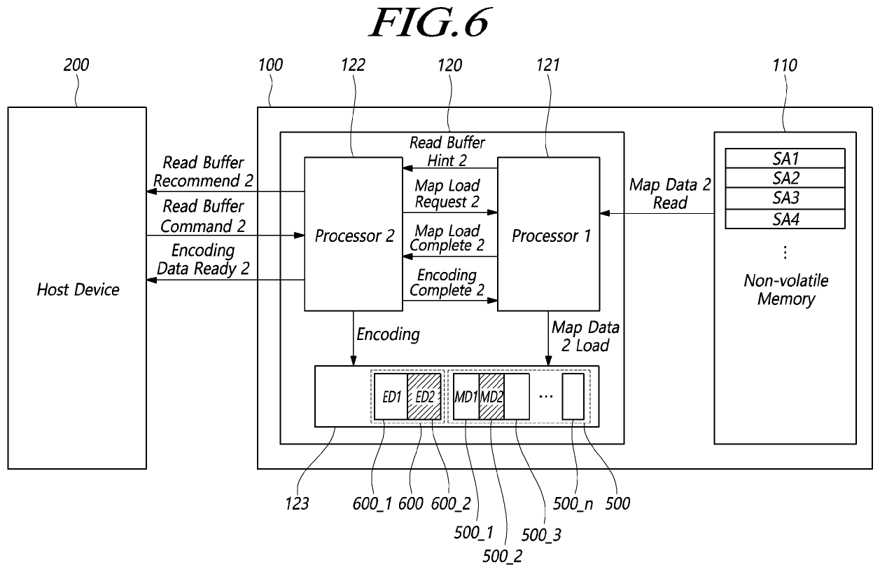

Referring to the example of FIG. 6, the first processor 121 may count read counts for storage areas SA, and may check a storage area SA whose read count is greater than or equal to the preset value.

For example, in a state in which the first map data MD1 for the first storage area SA1 is encoded and the first encoded data ED1 is stored in the first encoding area 600_1, a read count for the second storage area SA2 may be greater than or equal to the preset value.

The first processor 121 may output, to the second processor 122, a second read buffer hint signal according to the second storage area SA2. Also, the first processor 121 may start a load operation of storing second map data MD2 for the second storage area SA2 in the map load area 500 of the buffer memory 123. The load operation may be started before the second read buffer hint signal is outputted.

For example, the first processor 121 may store the second map data MD2 in the second map load area 500_2 of the buffer memory 123.

The second processor 122 may transmit, to the host device 200, a second read buffer recommend signal in response to the second read buffer hint signal. The second processor 122 may receive, from the host device 200, a second read buffer command corresponding to the second read buffer recommend signal. In response to the second read buffer command, the second processor 122 may transmit a second map load request signal to the first processor 121.

The first processor 121 may transmit, to the second processor 122, a second map load complete signal corresponding to the second map load request signal.

In response to the second map load complete signal, the second processor 122 may encode the second map data MD2 stored in the second map load area 500_2, and thereby, may store the encoded data ED2 in the second encoding area 600_2.

When storage of second encoded data ED2 in the second encoding area 600_2 is completed, the second processor 122 may transmit a second encoding data ready signal to the host device 200.

The second processor 122 may transmit a second encoding complete signal to the first processor 121. In response to the second encoding complete signal, the first processor 121 may recognize the second map load area 500_2 as a usable area.

In a state in which the first encoded data ED1 obtained by encoding the first map data MD1 is stored in the first encoding area 600_1, the second encoded data ED2 obtained by encoding the second map data MD2 may be stored in the second encoding area 600_2. A delay due to a time required for encoding in the process of providing map data to the host device 200 may be prevented or reduced.

When a time required to transmit, to the host device 200, the first encoded data ED1 of the first encoding area 600_1 is longer than a time required to encode the second map data MD2, or when the sum of a standby time to till the first encoded data ED1 of the first encoding area 600_1 is transmitted to the host device 200 and a transmission time is longer than the time required to encode the second map data MD2, the time required to encode the second map data MD2 may overlap with the standby time and/or transmission time of the first map data MD1. The transmission time may be corresponding to a time during which the encoded data of the encoding area is transmitted to the host device 200. The standby time may be corresponding to a time between a timing when storing the encoded data is completed and a timing when a transmission of the encoded data is started.

In the process of providing the first map data MD1 and the second map data MD2 to the host device 200, the time required to encode the second map data MD2 may not affect an overall time. An overall operation time may be a time that is reduced by at least a portion of the time required to encode the second map data MD2.

In this way, according to an embodiment of the disclosed technology, a time point at which a load operation of map data is started is adjusted, and an operation of providing map data to the host device 200 is performed by setting the plurality of map load areas 500 and the plurality of encoding areas 600. Therefore, a delay in the process of providing map data to the host device 200 may be prevented or reduced, and the performance of a read operation may be improved.

After encoded data are stored in the first encoding area 600_1 and the second encoding area 600_2, load and encoding operations of map data for a new storage area SA may be performed, and processing of additional map data may be performed in various ways according to states of the first encoding area 600_1 and the second encoding area 600_2.

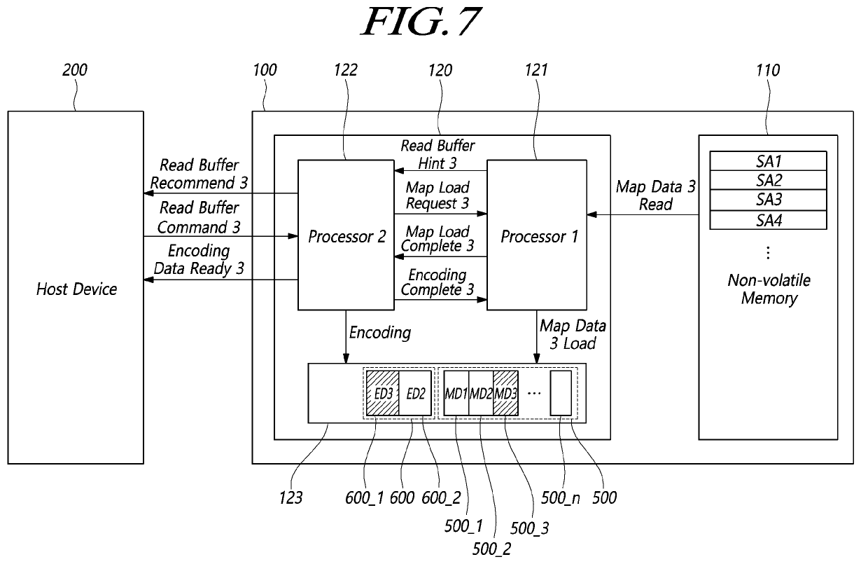

Referring to the example of FIG. 7, the first processor 121 may check that a read count for the third storage area SA3 of the memory 110 is greater than or equal to a preset value. The first processor 121 may transmit a third read buffer hint signal to the second processor 122, and may start a load operation of storing, in the buffer memory 123, third map data MD3 for the third storage area SA3.

For example, the third map data MD3 may be stored in the third map load area 500_3 of the buffer memory 123. Alternatively, when it is after the first processor 121 receiving the first encoding complete signal or the second encoding complete signal, the third map data MD3 may be stored in the first map load area 500_1 or the second map load area 500_2.

A third read buffer recommend signal may be transmitted to the host device 200 by the second processor 122. The second processor 122 may receive a third read buffer command from the host device 200, and may transmit a third map load request signal to the first processor 121. In response to a third map load complete signal from the first processor 121, the second processor 122 may perform encoding of the third map data MD3.

The second processor 122 may check whether the encoded data stored in the first encoding area 600_1 or the second encoding area 600_2 is transmitted. The encoded data stored in the first encoding area 600_1 or the second encoding area 600_2 may be transmitted according to a command of the host device 200, and it may be checked whether the transmission of the encoded data is completed to the host device through the physical layer of the controller 120.

The second processor 122 may encode the third map data MD3 and store encoded data in an encoding area 600 where transmission of encoded data is completed between the first encoding area 600_1 and the second encoding area 600_2. For example, when transmission of the first encoded data ED1 stored in the first encoding area 600_1 is completed, the second processor 122 may store, in the first encoding area 600_1, third encoded data ED3 obtained by encoding the third map data MD3.

Since encoding by the second processor 122 may be sequentially performed and encoded data may be taken by the host device 200, by a method of alternately using two encoding areas 600 or continuously using one of the two encoding areas 600, an influence of a time required for encoding to be exerted on an overall operation time may be prevented or reduced.

In one embodiment, the second processor 122 may perform an operation of encoding map data by modifying the encoding area 600 included in the buffer memory 123.

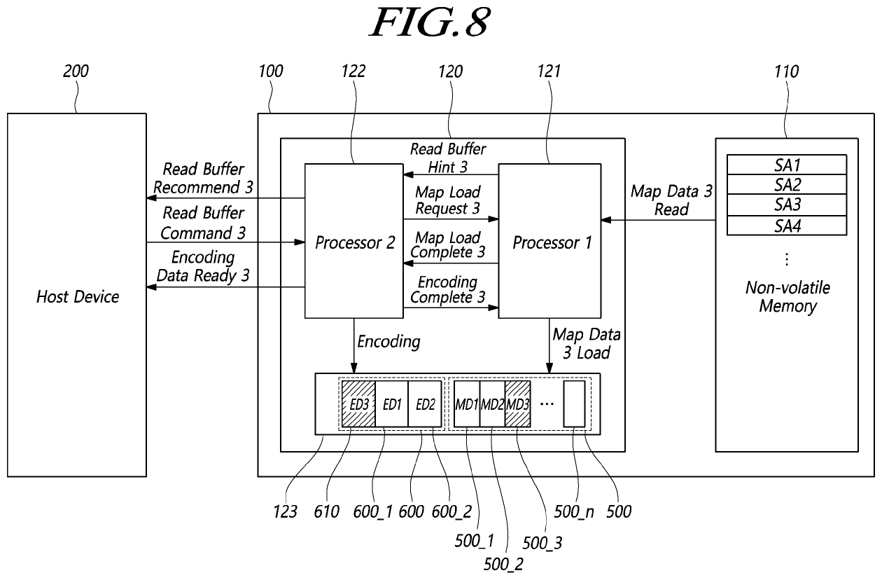

Referring to the example of FIG. 8, a state in which the first encoded data ED1 obtained by encoding the first map data MD1 is stored in the first encoding area 600_1 and the second encoded data ED2 obtained by encoding the second map data ED2 is stored in the second encoding area 600_2 is illustrated as an example.

By the first processor 121, a third read buffer hint signal may be outputted, and a load operation of third map data MD3 may be performed. For example, the third map data MD3 may be stored in the third map load area 500_3 of the buffer memory 123.

The second processor 122 may transmit a third read buffer recommend signal to the host device 200, and the host device 200 may transmit a third read buffer command to the second processor 122.

The second processor 122 may transmit a third map load request signal to the first processor 121, and may receive a third map load complete signal from the first processor 121.

In response to the third map load complete signal, the second processor 122 may encode the third map data MD3 stored in the third map load area 500_3.

When encoding the third map data MD3, the second processor 122 may check whether transmission of the encoded data stored in the first encoding area 600_1 and the second encoding area 600_2 is completed.

In the example described above with reference to FIG. 7, when there is a usable encoding area 600 between the first encoding area 600_1 and the second encoding area 600_2, the second processor 122 may store encoded data obtained by encoding the third map data MD3 using the corresponding encoding area 600.

When transmission of the encoded data stored in the first encoding area 600_1 or the second encoding area 600_2 is not completed, the second processor 122 may allocate an additional encoding area 610.

The additional encoding area 610 may be a portion of an area which is set to be variably used in the buffer memory 123.

The second processor 122 may encode the third map data MD3 and store the encoded data ED3 in the additional encoding area 610.

When encoding of the third map data MD3 is completed, the second processor 122 may transmit a third encoding data ready signal to the host device 200. The second processor 122 may transmit a third encoding complete signal to the first processor 121. The first processor 121 may recognize a state in which map data may be loaded into the third map load area 500_3.

As the second processor 122 performs encoding of map data using the first encoding area 600_1 and the second encoding area 600_2, it is possible to prevent or reduce delay in an overall operation caused by a time required for encoding.

In addition, as the second processor 122 variably sets the additional encoding area 610 depending on the use states of the first encoding area 600_1 and the second encoding area 600_2, it is possible to minimize a delay caused by an encoding operation in the process of providing a plurality of map data elements to the host device 200.

In the state in which the additional encoding area 610 is set, the second processor 122 may perform encoding of map data using the basically set encoding areas 600_1 and 600_2 or the additional encoding area 610 depending on whether transmission of encoded data is completed.

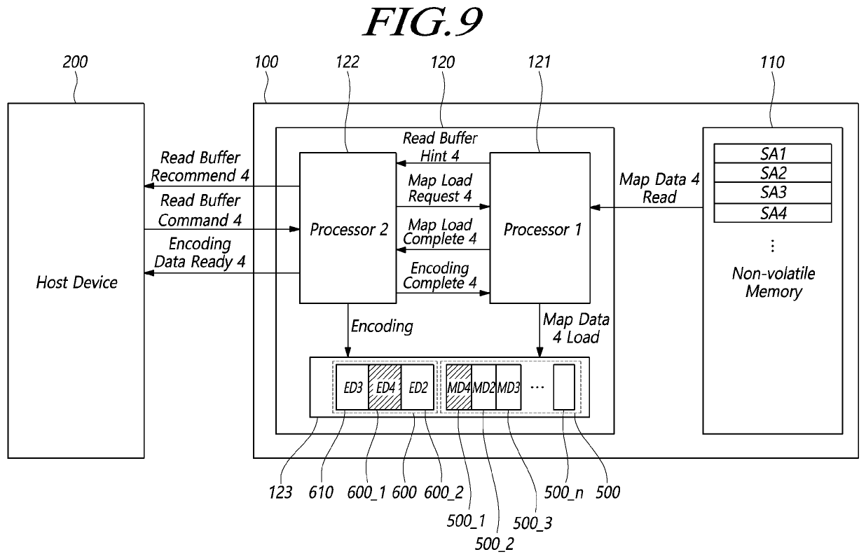

Referring to the example of FIG. 9, it is illustrated that a case where a load operation of new map data is performed in the state in which the additional encoding area 610 is set as in the example shown in FIG. 8.

The first processor 121 may output a fourth read buffer hint signal and load fourth map data MD4 for the fourth storage area SA4 into the buffer memory 123. When the first processor 121 recognizes that encoding of the first map data MD1 is completed, the first processor 121 may load the fourth map data MD4 into the first map load area 500_1.

A fourth read buffer recommend signal of the second processor 122 may be transmitted to the host device 200, and a fourth read buffer command of the host device 200 may be transmitted to the second processor 122.

The second processor 122 may transmit a fourth map load request signal to the first processor 121, and may start encoding of the fourth map data MD4 in response to a fourth map load complete signal.

The second processor 122 may check the use states of the first encoding area 600_1, the second encoding area 600_2 and the additional encoding area 610. When the encoded data of the first encoding area 600_1 is completely transmitted to the host device 200, the second processor 122 may store, in the first encoding area 600_1, fourth encoded data ED4 obtained by encoding the fourth map data MD4.

Alternatively, as in the example described above with reference to FIG. 8, when the existing encoding areas 600_1 and 600_2 and the additional encoding area 610 are being used, the second processor 122 may additionally set a separate additional encoding area 610, and may store, in the set additional encoding area 610, the fourth encoded data ED4 obtained by encoding the fourth map data MD4.

As described above, according to an embodiment of the disclosed technology, a load operation of map data may be started before a read buffer command or a map load request signal is received, and loading and encoding of map data may be performed using a plurality of map load areas and a plurality of encoding areas. Thus, it is possible to reduce delay according to an operation of providing map data to the host device 200.

Also, since loading and encoding of a plurality of map data elements may be performed, load operations or encoding operations of map data may be consecutively performed.

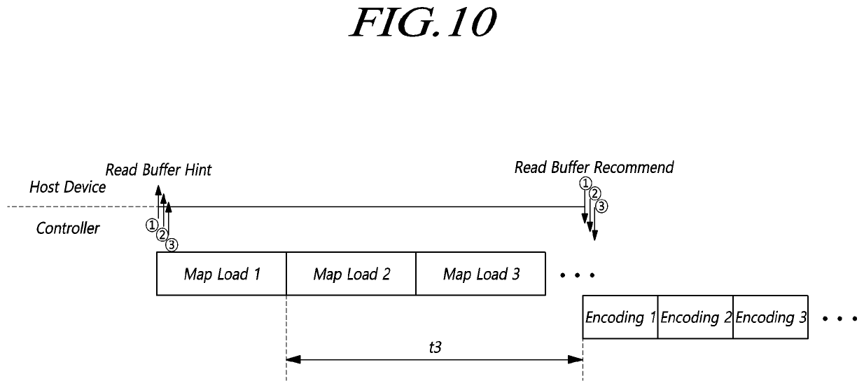

FIG. 10 is a diagram illustrating an example of a method in which the storage device 100 loads and encodes map data based on an embodiment of the disclosed technology.

Referring to FIG. 10, the controller 120 of the storage device 100 may transmit, to the host device 200, a read buffer recommend signal depending on a read count for a storage area SA of the memory 110.

When transmitting the read buffer recommend signal, the controller 120 may start an operation of loading corresponding map data into the buffer memory 123 regardless of whether a read buffer command is received. The load operation of the map data may be started before a read buffer hint signal is outputted, as in the above-described example.

The controller 120 may perform the load operation of the map data according to the generation of the read buffer hint signal before a read buffer command corresponding to the read buffer recommend signal is received.

For example, the controller 120 may transmit read buffer recommend signals (e.g., \textcircled{1}, \textcircled{2} and \textcircled{3}), and may perform load operations of map data (e.g., \textcircled{1}, \textcircled{2} and \textcircled{3}). Load operations of a plurality of map data elements may be performed, and load operations of at least two map data may be consecutively performed.

The controller 120 may receive, from the host device 200, read buffer commands corresponding to the read buffer recommend signals.

The controller 120 may perform operations of encoding map data in response to the read buffer commands.

Since a load operation of map data is started before a read buffer command is received, a time interval (e.g., t3) may exist between a time point at which the load operation of the map data is completed and a time point at which encoding of the corresponding map data is started.

Since a load operation of map data is performed by the first processor 121 of the controller 120, the load operation of map data may be performed each time a read buffer hint signal is generated. Thus, load operations of a plurality of map data elements may be consecutively performed.

Since an encoding operation of map data is performed by the second processor 122 of the controller 120, encoding operations of map data corresponding to received read buffer commands may be consecutively performed.

Since at least a portion of a load operation of map data is completed before a read buffer command is received, a time point at which an encoding operation of the map data is started may be advanced. In addition, since encoding operations on a plurality of map data elements may be consecutively performed, by using the plurality of encoding areas 600, before the host device 200 takes encoded data, delay in an overall operation time due to the encoding operation may be prevented or reduced.

Since map data may be efficiently provided while reducing a delay in a time required for an operation of providing map data to the host device 200 by the storage device 100, the performance of a read operation according to a read command of the host device 200 may be improved.

Although various embodiments of the disclosed technology have been described with particular specifics and varying details for illustrative purposes, those skilled in the art will appreciate that various modifications, additions and substitutions may be made based on what is disclosed or illustrated in the disclosed technology without departing from the spirit and scope of the disclosed technology as defined in the following claims. Furthermore, the embodiments May be combined to form additional embodiments.

What is claimed is:

1. A storage device comprising:
a memory including a plurality of storage areas; and
a controller configured to transmit, to a host device, a read buffer recommend signal on the basis of a read count for data stored in each of the plurality of storage areas, and start a load operation of storing, in a buffer memory, map data associated with the read buffer recommend signal before receiving, from the host device, a read buffer command corresponding to the read buffer recommend signal.

2. The storage device according to claim 1, wherein the controller transmits, to the host device, a first read buffer recommend signal and a second read buffer recommend signal, and stores, in a map load area of the buffer memory, first map data associated with the first read buffer recommend signal and second map data associated with the second read buffer recommend signal.

3. The storage device according to claim 2, wherein the second map data is stored in the map load area in a state in which the first map data is stored in the map load area of the buffer memory.

4. The storage device according to claim 2, wherein, in response to a first read buffer command, from the host device, corresponding to the first read buffer recommend signal, the controller encodes the first map data and stores the encoded first map data in a first encoding area of the buffer memory.

5. The storage device according to claim 4, wherein a time interval exists between a time point in which the first map data is stored in the map load area of the buffer memory and a time point in which the first map data is encoded.

6. The storage device according to claim 4, wherein, in response to a second read buffer command, from the host device, corresponding to the second read buffer recommend signal, the controller encodes the second map data and stores the encoded second map data in a second encoding area of the buffer memory.

7. The storage device according to claim 6, wherein the controller transmits, to the host device, a third read buffer recommend signal, and stores, in the map load area of the buffer memory, third map data associated with the third read buffer recommend signal.

8. The storage device according to claim 7, wherein, in response to a third read buffer command, from the host device, corresponding to the third read buffer recommend signal after at least one of the first map data and the second map data is transmitted to the host device, the controller encodes the third map data and stores the encoded third map data in the first encoding area or the second encoding area.

9. The storage device according to claim 7, wherein, in response to a third read buffer command, from the host device, corresponding to the third read buffer recommend signal before at least one of the first map data and the second map data is transmitted to the host device, the controller encodes the third map data and stores the encoded third map data in an additional encoding area of the buffer memory.

10. The storage device according to claim 1, wherein the controller comprises:
a first processor configured to output a read buffer hint signal when the read count for the data stored in each of the plurality of storage areas is greater than or equal to a preset value; and
a second processor configured to transmit, to the host device, the read buffer recommend signal in response to the read buffer hint signal.

11. The storage device according to claim 10, wherein the first processor starts the load operation before outputting the read buffer hint signal.

12. The storage device according to claim 10, wherein the second processor transmits, to the first processor, a map load request signal in response to the read buffer command, from the host device, corresponding to the read buffer recommend signal.

13. The storage device according to claim 12, wherein the load operation is completed before the first processor receives the map load request signal.

14. The storage device according to claim 12, wherein the second processor starts an operation of encoding the map data in response to a map load complete signal, from the first processor, corresponding to the map load request signal.

15. The storage device according to claim 1, wherein the buffer memory includes n number of map load areas in which the map data is stored and M number of encoding areas in which encoded data obtained by encoding the map data is stored, and wherein n and M are integers satisfying the relationship n≥M≥2.

16. A controller comprising:
a buffer memory;
a first processor configured to output a read buffer hint signal when a read count is greater than or equal to a preset value, the read count for data stored in each of a plurality of storage areas included in an external memory, and start a load operation of storing map data associated with the read buffer hint signal in the buffer memory; and
a second processor configured to transmit, to a host device, a read buffer recommend signal in response to the read buffer hint signal, the read buffer recommend signal being transmitted after the load operation is started.

17. The controller according to claim 16, wherein the load operation is started before the read buffer hint signal is outputted.

18. The controller according to claim 16, wherein the second processor transmits, to the first processor, a map load request signal in response to a read buffer command, from the host device, corresponding to the read buffer recommend signal, and the load operation is completed before the map load request signal is transmitted to the first processor.

19. A controller comprising:
a buffer memory;
a first processor configured to output a read buffer hint signal when a read count is greater than or equal to a preset value, the read count for data stored in each of a plurality of storage areas included in an external memory, and store, in a map load area of the buffer memory, map data associated with the read buffer hint signal; and
a second processor configured to transmit, to a host device, a read buffer recommend signal in response to the read buffer hint signal,
wherein the second processor transmits, to the host device, a first read buffer recommend signal and a second read buffer recommend signal, encodes first map data stored in a first map load area of the buffer memory and stores the encoded first map data in a first encoding area of the buffer memory in response to a first read buffer command corresponding to the first read buffer recommend signal, and encodes second map data stored in a second map load area of the buffer memory and stores the encoded second map data in a second encoding area of the buffer memory in response to a second read buffer command corresponding to the second read buffer recommend signal.

20. The controller according to claim 19, wherein a time point in which the first map data is encoded and a time point in which the second map data is encoded are consecutive.
